(19) United States
(12) Patent Application Publication
(10) Pub. No.: US 2026/0161731 A1
(43) Pub. Date: Jun. 11, 2026

(54) LOGIC FOR DETECTING ZERO HOT, ONE HOT, AND MULTI-HOT VECTORS

(71) Applicant: QUALCOMM Incorporated, San Diego, CA (US)

(72) Inventor: Sandeep Kumar DUBEY, Austin, TX (US)

(21) Appl. No.: 18/976,243

(22) Filed: Dec. 10, 2024

(51) Int. Cl. G06F 17/16

(52) U.S. Cl. CPC G06F 17/16

(57) ABSTRACT

A method of detecting vector values includes receiving an input vector of bits. The input vector has a vector length. The method also includes generating a reverse input vector as a reverse of the input vector. The method further includes encoding the input vector as a function of a number of bits for indexing the input vector to generate an encoded input vector. The method still further includes encoding the reverse input vector as the function of a number of bits for indexing the reverse input vector to generate an encoded reverse input vector. The method also includes setting one hot to TRUE in response to the encoded input vector being equal to an inversion of the encoded reverse input vector.

### BACKGROUND

### Field

Aspects of the present disclosure relate to computing devices, and more specifically to logic for detecting zero hot, one hot, and multi-hot vectors.

### Background

Mobile or portable computing devices include mobile phones, laptop, palmtop and tablet computers, portable digital assistants (PDAs), portable game consoles, and other portable electronic devices. Mobile computing devices are comprised of many electrical components that consume power and generate heat. The components (or compute devices) may include system-on-a-chip (SoC) devices, graphics processing unit (GPU) devices, neural processing unit (NPU) devices, digital signal processors (DSPs), and modems, among others.

In application-specific integrated circuit (ASIC) design, logic is needed for processing vectors. For example, logic to detect whether an array includes all zeros (zero hot) is valuable. Similarly, logic to detect whether only one bit in the vector is set (e.g., one hot) is useful. Logic to detect whether many bits are set is also desirable and may be referred to as multi-hot logic. Efficient logic for detecting zero hot, one hot, and multi-hot would be desirable.

### SUMMARY

In aspects of the present disclosure, a method of detecting vector values includes receiving an input vector of bits. The input vector has a vector length. The method also includes generating a reverse input vector as a reverse of the input vector. The method further includes encoding the input vector as a function of a number of bits for indexing the input vector to generate an encoded input vector. The method still further includes encoding the reverse input vector as the function of a number of bits for indexing the reverse input vector to generate an encoded reverse input vector. The method also includes setting one hot to TRUE in response to the encoded input vector being equal to an inversion of the encoded reverse input vector.

Other aspects of the present disclosure are directed to an apparatus. The apparatus has one or more memories and one or more processors coupled to the one or more memories. The processor(s) is configured to receive an input vector of bits. The input vector has a vector length. The processor(s) is also configured to generate a reverse input vector as a reverse of the input vector. The processor(s) is further configured to encode the input vector as a function of a number of bits for indexing the input vector to generate an encoded input vector. The processor(s) is still further configured to encode the reverse input vector as the function of a number of bits for indexing the reverse input vector to generate an encoded reverse input vector. The processor(s) is also configured to set one hot to TRUE in response to the encoded input vector being equal to an inversion of the encoded reverse input vector.

In other aspects of the present disclosure, a non-transitory computer-readable medium with program code recorded thereon is disclosed. The program code is executed by a processor and includes program code to receive an input vector of bits. The input vector has a vector length. The program code also includes program code to generate a reverse input vector as a reverse of the input vector. The program code further includes program code to encode the input vector as a function of a number of bits for indexing the input vector to generate an encoded input vector. The program code still further includes program code to encode the reverse input vector as the function of a number of bits for indexing the reverse input vector to generate an encoded reverse input vector. The program code also includes program code to set one hot to TRUE in response to the encoded input vector being equal to an inversion of the encoded reverse input vector.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), including a zero hot, one hot, multi-hot detector, in accordance with certain aspects of the present disclosure.

FIG. 2 is logic diagram illustrating logic gates for detecting zero hot, one hot, and multi-hot vectors.

FIG. 3 is a diagram illustrating an architecture for detecting zero hot, one hot, and multi-hot vectors, in accordance with various aspects of the present disclosure.

FIG. 4 is a flow diagram illustrating an example process performed, for example, by a computing device, in accordance with various aspects of the present disclosure.

FIG. 5 is a block diagram showing an exemplary wireless communications system in which a configuration of the present disclosure may be advantageously employed.

FIG. 6 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” or “XOR” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

In application-specific integrated circuit (ASIC) design, logic is needed for processing vectors. For example, logic to detect whether an array includes all zeros (e.g., zero hot) is valuable. Similarly, logic to detect whether only one bit in the vector is set (e.g., one hot) is useful. Logic to detect whether many bits are set is also desirable and may be referred to as multi-hot logic.

The zero hot calculation is based on a negative OR (NOR) gate. More specifically, all the bits of the input vector are processed by the NOR gate. If the output of the NOR gate is one, then the input vector is zero hot.

According to aspects of the present disclosure, to calculate one hot, zeros are appended to the input vector to make the vector length a perfect power of two. For example, if the original vector length is five bits, then the length is extended to eight bits, with three zeroes appended to the most significant bits. Next, the process reverses the extended input vector to generate a reverse extended input vector.

A first encoder then encodes the extended input vector to generate an encoded input vector, where the encoded input vector is a vector of width $clog2(VectorLength). The function $clog2 is the ceiling log base two function and VectorLength is the length of the extended input vector. A second encoder encodes the reverse extended input vector to generate an encoded reverse input vector.

The input vector is determined to be one hot if the inverted value of the encoded reverse input vector is equal to the value of the encoded input vector. If the values are not equal, then the input vector is either multi-hot or zero hot. In the case when the input vector is not one hot, then the vector is determined to be multi-hot or zero hot based on processing at a logical AND gate.

Particular aspects of the subject matter described in this disclosure can be implemented to realize one or more of the following potential advantages. In some examples, the described techniques, such as implementing zero hot, one hot, multi-hot detect logic by using the described encoder, use fewer gates than prior systems and have fewer logic stages, saving power, saving area, and reducing latency.

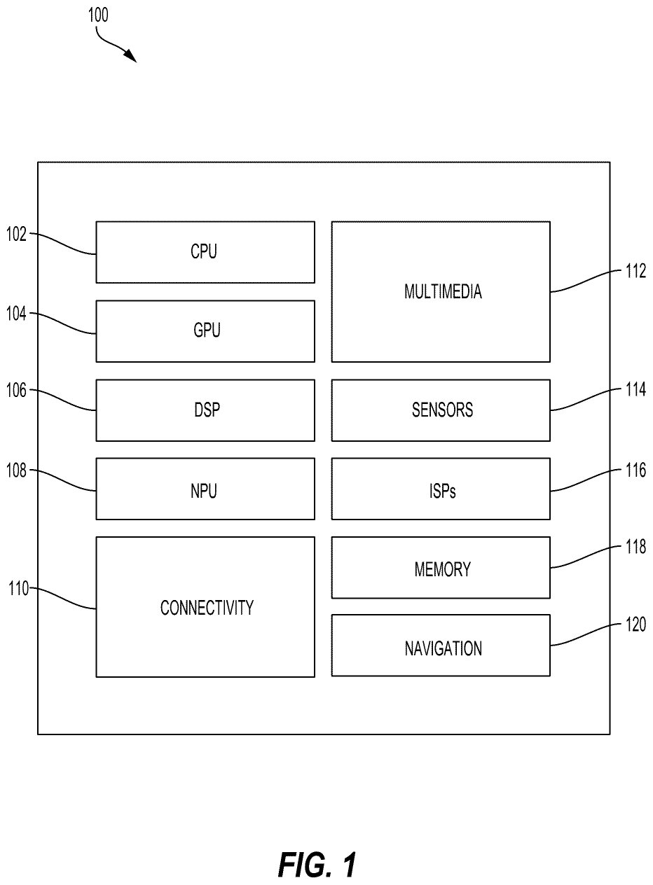

FIG. 1 illustrates an example implementation of a host system-on-a-chip (SoC) 100, which includes a zero hot, one hot, multi-hot detector, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set. Any of the CPU 102, GPU 104, DSP 106, and/or NPU 108 may include a zero hot, one hot, multi-hot detector, as will be described in more detail.

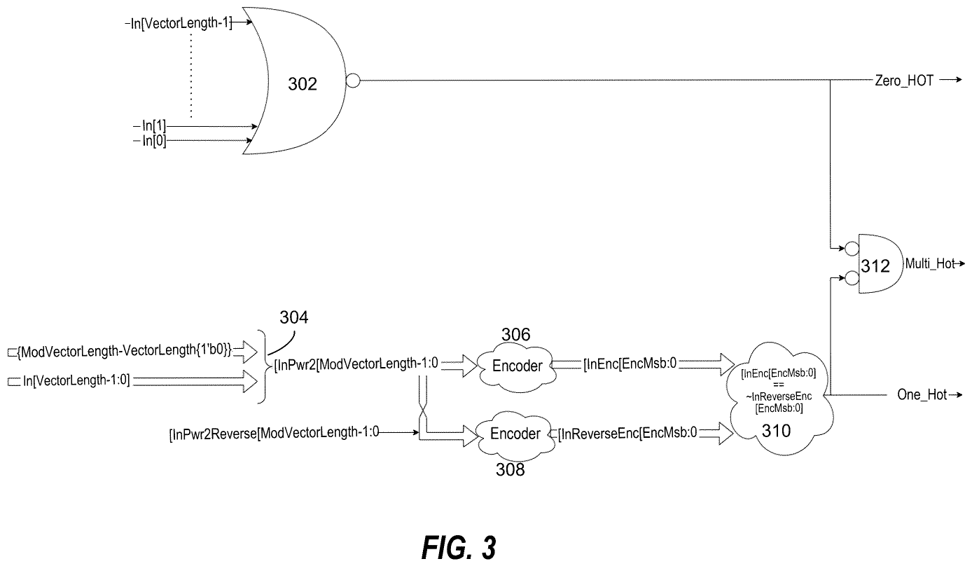

According to aspects of the present disclosure, a computing device includes a zero hot, one hot, multi-hot detector. The zero hot, one hot, multi-hot detector may include means for means for receiving, means for generating, means for encoding, means for setting, means for performing, and means for appending. In one configuration, the receiving means, the generating means, the encoding means, the setting means, the performing means and the appending means may be the logic, as shown in FIG. 3 executed in the CPU 102, GPU 104, DSP 106, NPU 108, and memory 118 of FIG. 1. In other aspects, the aforementioned means may be any structure or any material configured to perform the functions recited by the aforementioned means.

In application-specific integrated circuit (ASIC) design, logic is needed for processing vectors. For example, logic to detect whether an array includes all zeros (e.g., zero hot) is valuable. Similarly, logic to detect whether only one bit in the vector is set (e.g., one hot) is useful. Logic to detect whether many bits are set is also desirable and may be referred to as multi-hot logic.

Zero hot, one hot, and multi-hot logic may be used in determining whether a tag hit occurs or whether a translation lookaside buffer (TLB) hit occurs. For example, if tag hit is asserted and the value is one hot, then data from a cache is good to be consumed. If tag hit is asserted and the result is multi hot, then data from the cache should not be consumed and an error occurred. The result should be reported as an exception. If tag hit is not asserted (e.g., zero hot) then data should be filled from memory. If TLB hit is asserted and the result is one hot, then the translation from the TLB is good to be consumed. If TLB hit is asserted and the result is multi hot, then a bad software translation occurred, which should be reported as an exception. If TLB hit is not asserted (e.g., zero hot) then the memory management unit (MMU) should translate the virtual address to a physical address.

Such logic may also have applications in error detection, for example, for detecting software errors. The logic may also be used when allocating or merging an incoming request in a queue.

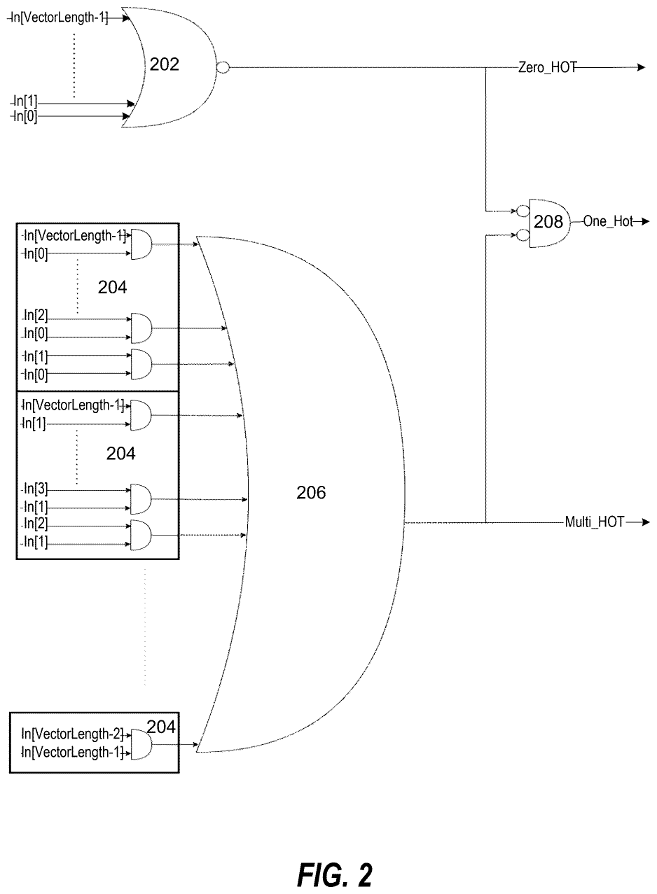

FIG. 2 is logic diagram illustrating logic gates for detecting zero hot, one hot, and multi-hot vectors. As seen in the example of FIG. 2, computing zero hot (e.g., a cache miss) includes performing a logical NOT operation on the result of a logical OR operation 202 for the input vector elements In[VectorLength-1:0], e.g., determining whether any bit is set in the input vector.

Computing if only one bit is set or more than one bit is set is more complex. Moreover, computing one hot and multi-hot generally occurs in a timing critical path. As seen in the example of FIG. 2, one configuration of gate stages to compute if two or more bits are set may perform logical AND operations 204 on all possible combinations of two input bits. A logical OR operation 206 for the output of all the AND gates 204 indicates whether two or more bits of the input vector are set (e.g., whether the vector is multi-hot). To compute all possible combinations of two input bits with the AND gates, nC2 gates are needed, where nC2 (n choose two) represents the number of combinations of two objects given n objects, and n is the vector length. Performing the logical OR operation for all the outputs specifies approximately n*(n−1)/2 inputs to the OR gate 206. The logic depth in terms of two input gates is approximately 2*$clog2(n), where $clog2(n) represents the ceiling log function for a vector length of n.

If the input vector is neither zero hot nor multi-hot then the vector is one hot, which can be computed with a logical AND operation 208 of the negatives of the zero hot and multi-hot computations.

The total gate depth, assuming two input negative AND/negative OR (NAND/NOR) gates, to determine zero hot is approximately $clog2(VectorLength), where VectorLength is the length of the input vector. The total gate depth to determine multi-hot is approximately 2*$clog2(VectorLength). The total gate depth to determine one hot is approximately (2*$clog2(VectorLength)+1). The total gate count to implement zero hot, one hot, and multi-hot is in the order of O(n²).

FIG. 3 is a diagram illustrating an architecture for detecting zero hot, one hot, and multi-hot vectors, in accordance with various aspects of the present disclosure. The zero hot calculation is based on a negative OR (NOR) gate 302. More specifically, all the bits of the input vector In[VectorLength-1:0] are processed by the NOR gate 302. If the output of the NOR gate 302 is one, then the input vector is zero hot, which is set is TRUE.

To calculate one hot, zeros are appended to the input vector In[VectorLength-1:0] to make the vector length a perfect power of two: InPwr2[ModVectorLength-1:0], as seen at 304 of FIG. 3. For example, if the original vector length is five bits, then the length is extended to eight bits, with three zeroes appended to the most significant bits of the vector. As seen at the program code below, the appended zeroes ({ModVectorLength-VectorLength{1′b0}}) are added to the input vector In[VectorLength-1:0] to generate the modified input vector InPwr2[ModVectorLength-1:0]. Sample program code for appending zeroes is as follows:

EncMsb = $clog2(VectorLength)−1
ModVectorLength = 2^{$clog2(VectorLength)}
for(genvar i = 0; i <= ModVectorLength; i++) begin
assign InPwr2Reverse[i] = InPwr2[ModVectorLength−1−i]
end

Next, the process reverses the modified input vector to generate a reverse input vector InPwr2Reverse[i]=InPwr2[ModVectorLength−1−i]. For example, the vector 1101 would be reversed to 1011. That is, the most significant bit (MSB) becomes the least significant bit (LSB), the second MSB becomes the second LSB, etc.

A first encoder 306 encodes the appended input vector InPwr2[ModVectorLength-1:0] to generate an encoded input vector InEnc[EncMsb:0], where (EncMsb=$clog2(VectorLength)−1).

A second encoder 308 encodes the appended reverse input vector InPwr2Reverse[ModVectorLength-1:0] to generate an encoded reverse input vector InEncReverse[EncMsb:0].

The encoding will now be described in greater detail. If an input vector has only one bit set then bit positions of the set bit can be determined by encoding the input vector. The encoder logic determines each bit by performing a logical OR operation with half of the bits of the input vector. For example, if the input vector is eight bits wide then encoder logic for the input vector is described in equation (1):

$$Enc [ 0 ] = In [ 1 ] \vert In [ 3 ] \vert In [ 5 ] \vert In [ 7 ] ; \qquad ( 1 )$$

$$Enc [ 1 ] = In [ 2 ] \vert In [ 3 ] \vert In [ 6 ] \vert In [ 7 ] ;$$

$$Enc [ 2 ] = In [ 4 ] \vert In [ 5 ] \vert In [ 6 ] \vert In [ 7 ] ,$$

where | represents the logical OR operation.

If the input vector is eight bits wide and the input vector is one hot, then the encoded value of the input vector when bits are set is as follows, where the first column in the table below represents the bit set, the second column represents the encoded value, and the third column represents the encoded value of the reverse vector:

TABLE 1

| | | Encoded Value of the |
|---|---|---|
| Bit Set | Encoded Value | Reverse Vector |
| 0 | 000 | 111 |
| 1 | 001 | 110 |
| 2 | 010 | 101 |
| 3 | 011 | 100 |
| 4 | 100 | 011 |
| 5 | 101 | 010 |
| 6 | 110 | 001 |
| 7 | 111 | 000 |

If the encoded value of the input vector is equal to the inverted value of the encoded reverse input vector, then the input vector is one hot. More specifically, if the input vector is one hot, then at block 310, the encoded input vector InEnc[EncMsb:0] is equal to the inversion of the encoded reverse input vector InEncReverse[EncMsb:0], in other words (InEnc[EncMsb:0]==˜InEncReverse[EncMsb:0]). Accordingly, one hot is set to TRUE.

If the values are not equal, then the input vector is either multi-hot or zero hot. The vector is determined to be multi-hot or zero hot at the AND gate 312. If the vector is multi-hot, multi-hot is set to TRUE based on the output of the AND gate 312.

An example is now described with respect to a five bit input vector having a value of 10010. Initially, the input vector is extended to eight bit as 00010010. In this example, the first bit (second least significant bit) and the fourth bits are set (e.g., equal to one). The reverse input vector is 01001000. Based on equation (1), the encoded input vector is 101=5, and the encoded reverse input vector 111=7. Because the inverted value of 101 (e.g., 010) does not equal 111, then the input vector is not one hot.

The encoding in the above example will now be described in more detail. The modified (or extended) input vector includes bits that are not set (e.g., zeroes) in the zero, second, third, fifth, and seventh positions. Set bits are located in the first position and in the fourth position. Referring to equation (1), Enc[0] is based on the first, third, fifth, and seventh positions. Because a bit is set in the first position, Enc[0]=1. Referring to equation (1) again, Enc[1] is based on the second, third, sixth, and seventh positions. Because no bit is set in these positions, Enc[1]=0. Referring to equation (1) one more time, Enc[2] is based on the fourth, fifth, sixth, and seventh positions. Because a bit is set in the fourth position, Enc[2]=1. Thus, the encoding of the extended input vector 00010010 is 101 (e.g., Enc[0], Enc[1], Enc[2]).

In another example, the input vector is 00010000. The encoded input vector is 100=4. The reverse input vector is 00001000. The encoded reverse input vector is 011=3. The inverted encoded reverse input vector of 100=011, which is the same as the encoded input vector 011. Thus, this input vector is determined to be one hot.

Implementing one hot detect logic by using the described encoder uses fewer gates than prior systems and has fewer logic stages. The total gate depth, assuming two input NAND/NOR gates, to determine zero hot is approximately $clog2(VectorLength). The total gate depth to determine one hot is approximately ($clog2(VectorLength)+$clog2($clog2(VectorLength))). The total gate depth to determine multi-hot is approximately ($clog2(VectorLength)+$clog2($clog2(VectorLength))+1). The proposed implementation has “$clog2(VectorLength)−$clog2($clog2(VectorLength))” fewer gates than the implementation described with respect to FIG. 2. If the input vector length is 16 bits wide, then the proposed implementation has two fewer gates. If the input vector length is 256 bits wide, then the proposed implementation has five fewer gates. The total gate count to implement zero hot, one hot, and multi-hot is on the order of O(n). The total number of two input gates using the encoder is on the order of O(n*$clog2(n)) while implementing traditional techniques requires gates on the order of O(n*n). The gate depth is also reduced by $clog2(n)−$clog2($clog2(n)). Thus, by implementing the logic efficiently, area and power are reduced and timing improves. For example, implementing the logic with fewer gates and fewer gate stages improves the critical timing path.

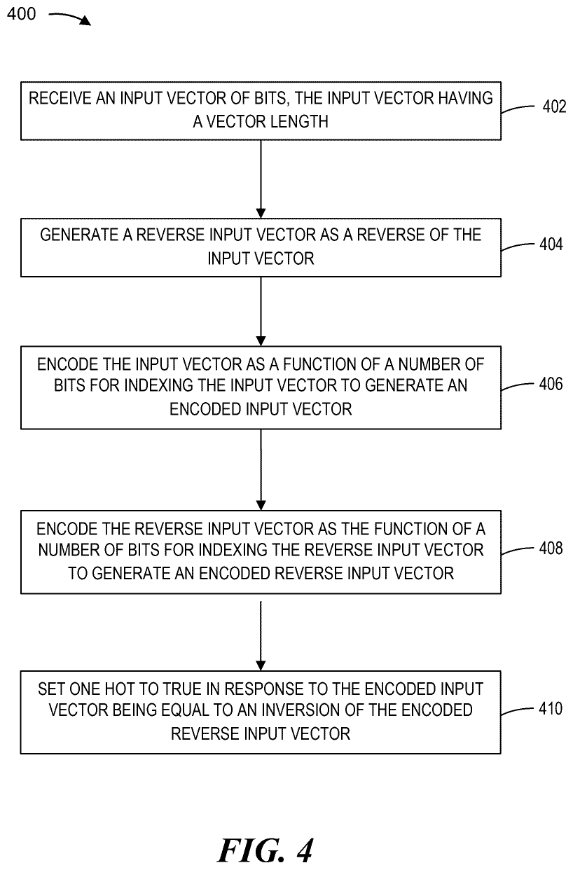

FIG. 4 is a flow diagram illustrating an example process 400 performed, for example, by a computing device, in accordance with various aspects of the present disclosure. The example process 400 is an example of zero hot, one hot, and multi-hot vector detection.

As shown in FIG. 4, in some aspects, the process 400 may include receiving an input vector of bits. The input vector has a vector length (block 402). In some aspects, the process appends zeroes to the input vector to increase the vector length to a perfect power of two. The process 400 may include generating a reverse input vector as a reverse of the input vector (block 404).

The process 400 may include encoding the input vector as a function of a number of bits for indexing the input vector to generate an encoded input vector (block 406). In some aspects, encoding the input vector comprises performing a logical OR operation on one half of the bits of the input vector.

The process 400 may include encoding the reverse input vector as the function of a number of bits for indexing the reverse input vector to generate an encoded reverse input vector (block 408).

The process 400 may include setting one hot to TRUE in response to the encoded input vector being equal to an inversion of the encoded reverse input vector (block 410).

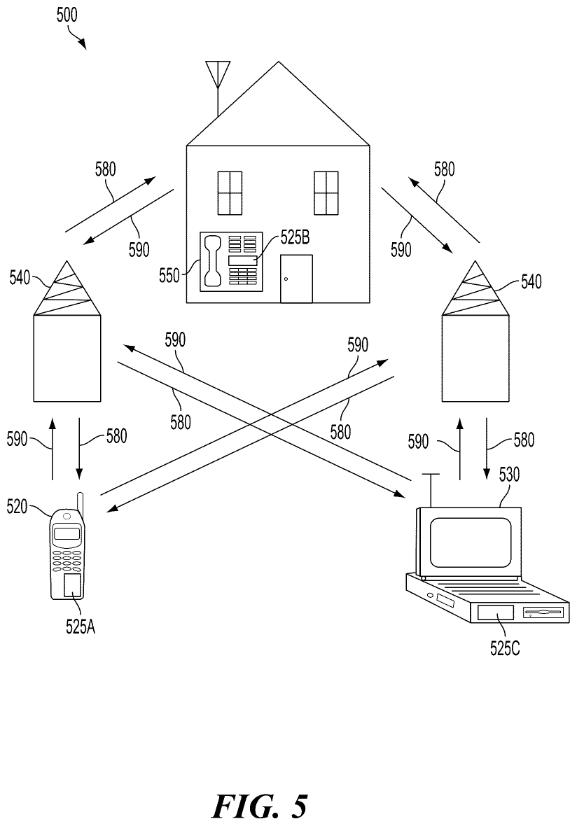

FIG. 5 is a block diagram showing an exemplary wireless communications system 500, in which an aspect of the present disclosure may be advantageously employed. For purposes of illustration, FIG. 5 shows three remote units 520, 530, and 550, and two base stations 540. It will be recognized that wireless communications systems may have many more remote units and base stations. Remote units 520, 530, and 550 include integrated circuit (IC) devices 525A, 525B, and 525C that include the disclosed zero hot, one hot, and multi-hot vector detection. It will be recognized that other devices may also include the disclosed zero hot, one hot, and multi-hot vector detection, such as the base stations, switching devices, and network equipment. FIG. 5 shows forward link signals 580 from the base stations 540 to the remote units 520, 530, and 550, and reverse link signals 590 from the remote units 520, 530, and 550 to the base stations 540.

In FIG. 5, remote unit 520 is shown as a mobile telephone, remote unit 530 is shown as a portable computer, and remote unit 550 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 5 illustrates remote units according to the aspects of the present disclosure, the disclosure is not limited to these exemplary illustrated units. Aspects of the present disclosure may be suitably employed in many devices, which include the disclosed logic for detecting zero hot, one hot, and multi-hot vectors.

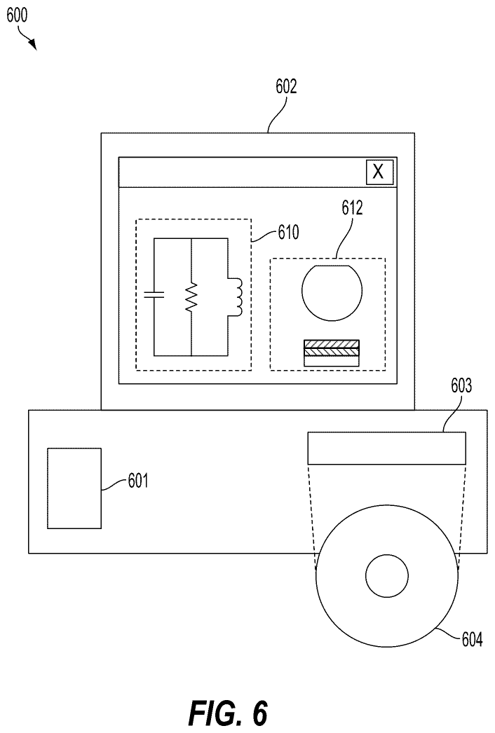

FIG. 6 is a block diagram illustrating a design workstation 600 used for circuit, layout, and logic design of a semiconductor component, such as the logic for detecting zero hot, one hot, and multi-hot vectors disclosed above. The design workstation 600 includes a hard disk 601 containing operating system software, support files, and design software such as Cadence or OrCAD. The design workstation 600 also includes a display 602 to facilitate design of a circuit 610 or a semiconductor component 612, such as the logic for detecting zero hot, one hot, and multi-hot vectors. A storage medium 604 is provided for tangibly storing the design of the circuit 610 or the semiconductor component 612 (e.g., the PLD). The design of the circuit 610 or the semiconductor component 612 may be stored on the storage medium 604 in a file format such as GDSII or GERBER. The storage medium 604 may be a CD-ROM, DVD, hard disk, flash memory, or other appropriate device. Furthermore, the design workstation 600 includes a drive apparatus 603 for accepting input from or writing output to the storage medium 604.

Data recorded on the storage medium 604 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 604 facilitates the design of the circuit 610 or the semiconductor component 612 by decreasing the number of processes for designing semiconductor wafers.

### EXAMPLE ASPECTS

Aspect 1: A method of detecting vector values, comprising: receiving an input vector of bits, the input vector having a vector length; generating a reverse input vector as a reverse of the input vector; encoding the input vector as a function of a number of bits for indexing the input vector to generate an encoded input vector; encoding the reverse input vector as the function of a number of bits for indexing the reverse input vector to generate an encoded reverse input vector; and setting one hot to TRUE in response to the encoded input vector being equal to an inversion of the encoded reverse input vector.

Aspect 2: The method of Aspect 1, further comprising: performing a logical negative OR (NOR) operation on each bit of the input vector; and setting zero hot to TRUE or FALSE in accordance with an output of the NOR operation.

Aspect 3: The method of Aspect 1 or 2, further comprising setting multi-hot to TRUE in response to one hot being FALSE and zero hot being FALSE.

Aspect 4: The method of any of the preceding Aspects, in which zero hot is TRUE in response to a result of the NOR operation being one.

Aspect 5: The method of any of the preceding Aspects, further comprising appending zeroes to the input vector to increase the vector length to a perfect power of two.

Aspect 6: The method of any of the preceding Aspects, in which encoding the input vector comprises performing a logical OR operation on one half of the bits of the input vector.

Aspect 7: The method of any of the preceding Aspects, in which each output bit of the encoding has a different combination of bits from the input vector.

Aspect 8: An apparatus for detecting vector values, comprising: at least one memory; and at least one processor coupled to the at least one memory, the at least one processor configured: to receive an input vector of bits, the input vector having a vector length; to generate a reverse input vector as a reverse of the input vector; to encode the input vector as a function of a number of bits for indexing the input vector to generate an encoded input vector; to encode the reverse input vector as the function of a number of bits for indexing the reverse input vector to generate an encoded reverse input vector; and to set one hot to TRUE in response to the encoded input vector being equal to an inversion of the encoded reverse input vector.

Aspect 9: The apparatus of Aspect 8, in which the at least one processor is further configured: to perform a logical negative OR (NOR) operation on each bit of the input vector; and to set zero hot to TRUE or FALSE in accordance with an output of the NOR operation.

Aspect 10: The apparatus of Aspect 8 or 9, in which the at least one processor is further configured to set multi-hot to TRUE in response to one hot being FALSE and zero hot being FALSE.

Aspect 11: The apparatus of any of the Aspects 8-10, in which zero hot is TRUE in response to a result of the NOR operation being one.

Aspect 12: The apparatus of any of the Aspects 8-11, in which the at least one processor is further configured to append zeroes to the input vector to increase the vector length to a perfect power of two.

Aspect 13: The apparatus of any of the Aspects 8-12, in which the at least one processor is further configured to perform a logical OR operation on one half of the bits of the input vector.

Aspect 14: The apparatus for detecting vector values of any of the Aspects 8-13, in which each output bit of the encoding has a different combination of bits from the input vector.

Aspect 15: A non-transitory computer-readable medium having program code recorded thereon, the program code executed by a processor and comprising: program code to receive an input vector of bits, the input vector having a vector length; program code to generate a reverse input vector as a reverse of the input vector; program code to encode the input vector as a function of a number of bits for indexing the input vector to generate an encoded input vector; program code to encode the reverse input vector as the function of a number of bits for indexing the reverse input vector to generate an encoded reverse input vector; and program code to set one hot to TRUE in response to the encoded input vector being equal to an inversion of the encoded reverse input vector.

Aspect 16: The non-transitory computer-readable medium of Aspect 15, in which the program code comprises: program code to perform a logical negative OR (NOR) operation on each bit of the input vector; and program code to set zero hot to TRUE or FALSE in accordance with an output of the NOR operation.

Aspect 17: The non-transitory computer-readable medium of Aspect 15 or 16, in which the program code comprises program code to set multi-hot to TRUE in response to one hot being FALSE and zero hot being FALSE.

Aspect 18: The non-transitory computer-readable medium of any of the Aspects 15-1, in which zero hot is TRUE in response to a result of the NOR operation being one.

Aspect 19: The non-transitory computer-readable medium of any of the Aspects 15-18, in which the program code comprises program code to append zeroes to the input vector to increase the vector length to a perfect power of two.

Aspect 20: The non-transitory computer-readable medium of any of the Aspects 15-19, in which the program code comprises program code to perform a logical OR operation on one half of the bits of the input vector.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above, and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

What is claimed is:

1. A method of detecting vector values, comprising:
receiving an input vector of bits, the input vector having a vector length;
generating a reverse input vector as a reverse of the input vector;
encoding the input vector as a function of a number of bits for indexing the input vector to generate an encoded input vector;
encoding the reverse input vector as the function of a number of bits for indexing the reverse input vector to generate an encoded reverse input vector; and
setting one hot to TRUE in response to the encoded input vector being equal to an inversion of the encoded reverse input vector.

2. The method of claim 1, further comprising:
performing a logical negative OR (NOR) operation on each bit of the input vector; and
setting zero hot to TRUE or FALSE in accordance with an output of the NOR operation.

3. The method of claim 2, further comprising setting multi-hot to TRUE in response to one hot being FALSE and zero hot being FALSE.

4. The method of claim 2, in which zero hot is TRUE in response to a result of the NOR operation being one.

5. The method of claim 1, further comprising appending zeroes to the input vector to increase the vector length to a perfect power of two.

6. The method of claim 1, in which encoding the input vector comprises performing a logical OR operation on one half of the bits of the input vector.

7. The method of claim 6, in which each output bit of the encoding has a different combination of bits from the input vector.

8. An apparatus for detecting vector values, comprising:
at least one memory; and
at least one processor coupled to the at least one memory, the at least one processor configured:
to receive an input vector of bits, the input vector having a vector length;
to generate a reverse input vector as a reverse of the input vector;
to encode the input vector as a function of a number of bits for indexing the input vector to generate an encoded input vector;
to encode the reverse input vector as the function of a number of bits for indexing the reverse input vector to generate an encoded reverse input vector; and
to set one hot to TRUE in response to the encoded input vector being equal to an inversion of the encoded reverse input vector.

9. The apparatus of claim 8, in which the at least one processor is further configured:
to perform a logical negative OR (NOR) operation on each bit of the input vector; and
to set zero hot to TRUE or FALSE in accordance with an output of the NOR operation.

10. The apparatus of claim 9, in which the at least one processor is further configured to set multi-hot to TRUE in response to one hot being FALSE and zero hot being FALSE.

11. The apparatus of claim 9, in which zero hot is TRUE in response to a result of the NOR operation being one.

12. The apparatus of claim 8, in which the at least one processor is further configured to append zeroes to the input vector to increase the vector length to a perfect power of two.

13. The apparatus of claim 8, in which the at least one processor is further configured to perform a logical OR operation on one half of the bits of the input vector.

14. The apparatus for detecting vector values of claim 8, in which each output bit of the encoding has a different combination of bits from the input vector.

15. A non-transitory computer-readable medium having program code recorded thereon, the program code executed by a processor and comprising:
program code to receive an input vector of bits, the input vector having a vector length;
program code to generate a reverse input vector as a reverse of the input vector;
program code to encode the input vector as a function of a number of bits for indexing the input vector to generate an encoded input vector;
program code to encode the reverse input vector as the function of a number of bits for indexing the reverse input vector to generate an encoded reverse input vector; and
program code to set one hot to TRUE in response to the encoded input vector being equal to an inversion of the encoded reverse input vector.

16. The non-transitory computer-readable medium of claim 15, in which the program code comprises:
program code to perform a logical negative OR (NOR) operation on each bit of the input vector; and
program code to set zero hot to TRUE or FALSE in accordance with an output of the NOR operation.

17. The non-transitory computer-readable medium of claim 16, in which the program code comprises program code to set multi-hot to TRUE in response to one hot being FALSE and zero hot being FALSE.

18. The non-transitory computer-readable medium of claim 16, in which zero hot is TRUE in response to a result of the NOR operation being one.

19. The non-transitory computer-readable medium of claim 15, in which the program code comprises program code to append zeroes to the input vector to increase the vector length to a perfect power of two.

20. The non-transitory computer-readable medium of claim 15, in which the program code comprises program code to perform a logical OR operation on one half of the bits of the input vector.
